(19) United States
(12) Patent Application Publication
(10) Pub. No.: US 2006/0143860 A1
(43) Pub. Date: Jul. 6, 2006

(54) Refrigerator

(75) Inventors: Eun-Seong Park, Jeonju-si (KR); Duck-Ho Han, Nam-gu (KR); Sung-Cheol Kang, Gwangsan-gu (KR); Bu-Kil Jeong, Gwangsan-gu (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/295,624

(22) Filed: Dec. 7, 2005

(30) Foreign Application Priority Data
Jan. 6, 2005 (KR) 10-2005-0001192
Oct. 4, 2005 (KR) 10-2005-0092960

(51) Int. Cl. E05D 7/04

(52) U.S. Cl. 16/243

(57) ABSTRACT

A refrigerator including a refrigerator main body having at least one freezing compartment, and a door to open and close the freezing compartment, the refrigerator including a hinge unit including a hinge shaft which is provided in one of the refrigerator main body and the door, and having an accommodating part to penetrate an inside of the hinge shaft, and a hinge groove which is provided in the other one of the refrigerator main body and the door to rotatably accommodate the hinge shaft, and a height adjusting unit which is coupled to the hinge shaft and the hinge groove to adjust a height of the door, and includes a height adjusting member which is provided between the hinge shaft and the hinge groove. Thus, the present invention provides a refrigerator which mounts a hinge unit and a height adjusting unit in a small space therein without difficulty.

### CROSS-REFERENCE TO RELATED APPLICATIONS

This application claims the benefit of Korean Patent Application No. 10-2005-0001192, filed on Jan. 6, 2005 and Application No. 10-2005-0092960, filed on Oct. 4, 2005, in the Korean Intellectual Property Office, the disclosures of which is incorporated herein by reference.

### BACKGROUND OF THE INVENTION

1. Field of the Invention

The present invention relates to a refrigerator. More particularly, to a refrigerator having an improved configuration of adjusting a height of a door of the refrigerator.

2. Description of the Related Art

Generally, a conventional refrigerator includes a plurality of freezing compartments, and front openings of the respective freezing compartments are open and closed by doors.

In the conventional refrigerator, a plurality of doors may fail to be parallel with each other due to assembling errors or may have different height with each other due to repeated opening and closing operations of a user.

Korea Utility Model No. 20-0270681 discloses a long bolt which adjusts a height of a door to solve the foregoing problem.

When a door is lower than another door, the long bolt may be fastened to raise the position of a hinge shaft, thereby raising the height of the door. Conversely, when a door is higher than another one, the door may be loosened to adjust the height of the door.

However, the conventional apparatus of adjusting the height of the door requires a larger installation space to mount a fixing plate supporting the hinge shaft in a main body cabinet so that it is lifted up and down with respect to the main body cabinet together with the hinge shaft. Also, the conventional apparatus of adjusting the height of the door is disposed in a lower part of a refrigerator instead of being installed in a middle part thereof, to thereby not be exposed to the outside and not offer an unsatisfactory external appearance.

To solve the foregoing problems, a door height adjusting apparatus is needed which is installed in a small space and offers a good external appearance.

### SUMMARY OF THE INVENTION

Accordingly, it is an aspect of the present invention to provide a refrigerator which mounts a hinge unit and a height adjusting unit in a small space therein without difficulty.

Additional aspects and/or advantages of the present invention will be set forth in part in the description which follows and, in part, will be apparent from the description, or may be learned by practice of the present invention.

The foregoing and/or other aspects of the present invention are achieved by providing a refrigerator including a refrigerator main body having at least one freezing compartment, and a door to open and close the freezing compartment, the refrigerator including a hinge unit including a hinge shaft which is provided in one of the refrigerator main body and the door, and having an accommodating part to penetrate an inside of the hinge shaft, and a hinge groove which is provided in the other one of the refrigerator main body and the door, to rotatably accommodate the hinge shaft, and a height adjusting unit which is coupled with the hinge shaft and the hinge groove to adjust a height of the door, and includes a height adjusting member which is provided between the hinge shaft and the hinge groove, and a height adjusting bolt which is screw-coupled with the accommodating part, to move the height adjusting member in an axial direction of the hinge shaft, and formed with a tool insertion part to which a tool is inserted.

The accommodating part penetrates in the hinge shaft in upward and downward directions, and the height adjusting member slides in upward and downward directions with respect to the hinge shaft, wherein a first side thereof is contacted with an internal surface of the hinge groove and a second side thereof is connected to the height adjusting bolt.

The height adjusting member includes a head which is exposed to an outside of the hinge shaft to be contacted with the internal surface of the hinge groove and a leg which includes a smaller diameter than the head contacts with the height adjusting bolt to slide within the accommodating part in upward and downward directions.

The accommodating part penetrates in the hinge shaft in the upward and downward directions, and the height adjusting member is provided in an outside of the hinge shaft to accommodate the hinge shaft and to be contacted with the hinge groove.

The hinge unit further includes a hinge bracket which is disposed in the refrigerator main body to be positioned in a lower part of the door, and the hinge shaft is provided in the hinge bracket.

The hinge bracket includes a first supporter to be coupled with the refrigerator main body and a second supporter which is provided in a transverse direction to a plate surface of the first supporter and formed with the hinge shaft.

The refrigerator further includes a rotation preventing unit to prevent the height adjusting member from rotating in opening and closing directions of the door with respect to the hinge shaft.

The rotation preventing unit includes a rotation preventing groove which is provided in the hinge shaft and a projection which is provided in the height adjusting member to be held in the rotation preventing groove to prevent the height adjusting member from rotating around an axis of the hinge shaft.

The refrigerator further includes a rotation preventing unit to prevent the height adjusting member from rotating in the opening and closing directions of the door with respect to the hinge shaft.

The rotation preventing unit includes a rotation preventing part which is provided in the hinge shaft and a projection which is provided in the height adjusting member through the rotation preventing part to prevent the height adjusting member from rotating around the axis of the hinge shaft.

The rotation preventing part is formed with a plain surface on an external circumferential surface of the hinge shaft and the projection includes a plate surface corresponding to a plain surface shape of the rotation preventing part to be prevented from rotating in contact with the rotation preventing part.

It is another aspect of the present invention to provide a refrigerator including a refrigerator main body having at least one freezing compartment, and a door to open and close the freezing compartment, the refrigerator including a hinge bracket which is provided in the refrigerator main body, a hinge shaft which is provided in the hinge bracket to rotatably support the door, and having an accommodating part which penetrates inside the hinge shaft, a hinge groove which is provided in a lower part of the door to rotatably accommodate the hinge shaft, and a height adjusting bolt which is screw-coupled with the accommodating part to move in upward and downward directions within the accommodating part and to adjust a height of the door.

The refrigerator further includes a height adjusting member which is provided between the hinge shaft and the hinge groove to slide in the upward and downward directions by the height adjusting bolt.

The refrigerator further includes a rotation preventing unit to prevent the height adjusting member from rotating in opening and closing directions of the door with respect to the hinge shaft.

The rotation preventing unit includes a rotation preventing part which is provided in the hinge shaft and a projection which is provided in the height adjusting member to prevent the height adjusting member from rotating around an axis of the hinge shaft to be held in the rotation preventing part.

The refrigerator further includes a rotation preventing groove which is provided in the hinge shaft and a projection which is provided in the height adjusting member to prevent the height adjusting member from rotating around the axis of the hinge shaft by being accommodated in the rotation preventing groove.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a perspective view of a refrigerator according to an embodiment of the present invention when a door thereof is open;

FIG. 2 illustrates an enlarged view of a hinge unit and a height adjusting unit of the refrigerator according to an embodiment of the present invention;

FIG. 3 illustrates an exploded view of the hinge unit and the height adjusting unit of the refrigerator according to an embodiment of the present invention;

FIGS. 4a and 4b illustrate operational views of the height adjusting unit according to an embodiment of the present invention;

FIG. 5 illustrates an exploded view of a rotation preventing unit which is provided in the hinge unit and the height adjusting unit in FIG. 3; and

FIG. 6 illustrates an exploded view of the hinge unit and the height adjusting unit according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below to explain the present invention by referring to the figures.

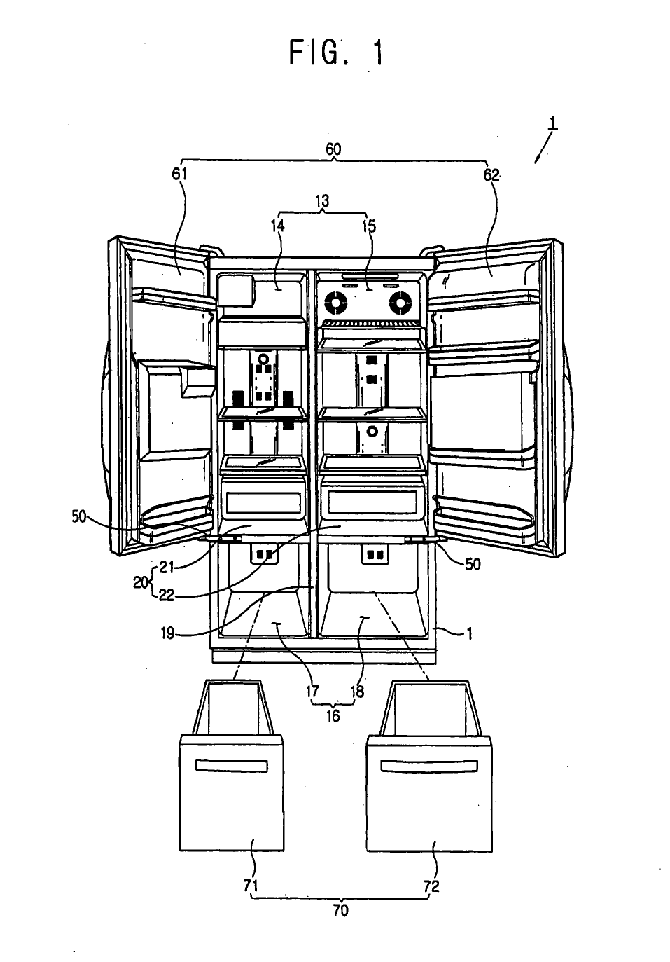

In FIGS. 1 through 3, a refrigerator according to an embodiment of the present invention comprises a refrigerator main body 1 having a main storage compartment 13 and an auxiliary storage compartment 16; and a main door 60 and an auxiliary door 70 which are provided in the refrigerator main body 1 to open and close the main storage compartment 13 and the auxiliary storage compartment 16, respectively.

The main storage compartment 13 is disposed on a upper part of the refrigerator main body 1. The main storage compartment 13 comprises a freezing compartment 14 and a refrigerating compartment 15 which are divided into two parts in a vertical direction by a main partition 19.

The auxiliary storage compartment 16 comprises temperature ranges from a refrigerating temperature to a freezing temperature. Generally, the auxiliary storage compartment 16 has a smaller space than the main storage compartment 13. The auxiliary storage compartment 16 is disposed on a lower part of the refrigerator main body 1, and distinguished from the main storage compartment 13 by an auxiliary partition 20 upwardly and downwardly. The auxiliary storage compartment 16 comprises a left auxiliary storage compartment 17 and a right auxiliary storage compartment 18 which are divided by the main partition 19 extended downwardly.

The auxiliary partition 20 comprises a freezing compartment auxiliary partition 21 which divides the freezing compartment 14 and the left auxiliary storage compartment 17 into upper and lower parts, and a refrigerating compartment auxiliary partition 22 which divides the refrigerating compartment 15 and the right auxiliary storage compartment 18 into upper and lower parts.

The main door 60 comprises a freezing compartment door 61 to rotatably open and close the freezing compartment 14, and a refrigerating compartment door 62 to rotatably open and close the refrigerating compartment 15. The auxiliary door 70 comprises a left auxiliary storage compartment door 71 to slidably open and close the left auxiliary storage compartment 17, and a right auxiliary storage compartment door 72 to slidably open and close the right auxiliary storage compartment 18.

Upper and lower parts of the freezing compartment door 61 and the refrigerating compartment door 62 are supported to the refrigerator main body 1 by a upper hinge unit (not shown) and lower hinge units 50, 55 and 57, thereby rotatably opening and closing front openings of the freezing compartment 14 and the refrigerating compartment 15.

As the lower hinge unit of the refrigerating compartment door 62 and the lower hinge unit of the freezing compartment door 61 comprise the same configuration, the lower hinge unit of the refrigerating compartment 62 alone will be described hereinafter.

The lower hinge unit of the refrigerating compartment door 62 comprises a hinge groove 57 which is formed on a lower part of the refrigerating compartment door 62, a hinge bracket 50 which is provided on a lower part of the front opening of the refrigerating compartment 15 to rotatably support the lower part of the refrigerating compartment door 62, and a hinge shaft 55 which is integrally provided in the hinge bracket 50 to accommodate the hinge groove 57.

The height of the refrigerating compartment door 62 rotatably coupled with the refrigerator main body 1 by the lower hinge unit may be changed by a height adjusting unit.

The hinge bracket 50 comprises an “L” shape and comprises a first supporter 51 which is coupled to the refrigerator main body 1, and a second support 52 which is extended from the first supporter 51 in a transverse direction with respect to a plate surface of the first supporter 51 and has the hinge shaft 55.

The first supporter 51 comprising a plurality of coupling holes 53 which penetrate the plate surface thereof. The first supporter 51 is coupled with the refrigerator main body 1 by screws 54 which are inserted into the coupling holes 53.

The second supporter 52 is extended from the first supporter 51 to protrude in a forward direction with respect to the refrigerator main body 1. On a first side of the second supporter 52 is extendedly formed the hinge shaft 55 to be accommodated in the hinge groove 57 of the refrigerating compartment door 62 in a standing direction.

The hinge shaft 55 comprises an accommodating part 56 therein which is penetrated in upward and downward directions. The accommodating part 56 is formed with a female screw to be screw-coupled with a height adjusting bolt 30 (to be described later).

The height adjusting unit comprises the height adjusting bolt 30 to be screw-coupled to the accommodating part 56 of the hinge shaft 55, and a height adjusting member 40 which is accommodated in the accommodating part 56 of the hinge shaft 55 to slide in upward and downward directions by a rotation of the height adjusting bolt 30.

On an external circumferential surface of the height adjusting bolt 30 is formed a male screw corresponding to the female screw formed in the accommodating part 56 of the hinge shaft 55. A lower part of the height adjusting bolt 30 comprises a tool insertion part 31 to which a tool 32 such as a wrench or a driver is inserted for the rotation of the height adjusting bolt 30.

Then, a user may insert the tool 32 to the tool insertion part 31 and rotate the height adjusting bolt 30 within the accommodating part 56 of the hinge shaft 55 to raise or lower the height adjusting bolt 30.

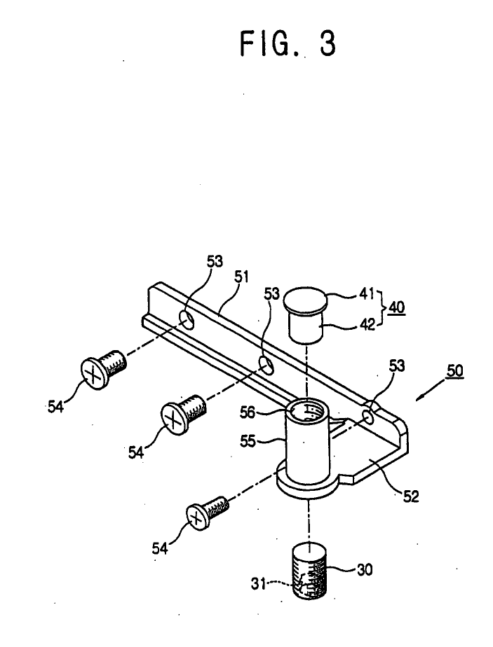

As shown in FIG. 3, the height adjusting member 40 comprises a head 41 which is exposed to an outside of the hinge shaft 55 to be contacted with the hinge groove 57 of the refrigerating compartment door 62; and a leg 42 which is slidably accommodated in the accommodating part 56 of the hinge shaft 55 to be contacted with a upper part of the height adjusting bolt 30. If the height adjusting bolt 40 rises, the height adjusting member 40 slides also upwardly. When the height adjusting bolt 30 is lowered, the height adjusting member 40 is also lowered by gravity.

With this configuration, in the refrigerator according to the present invention, the following method may be applicable to find levels of the doors when a stepped pulley is positioned between the refrigerating compartment door 62 and the freezing compartment door 61.

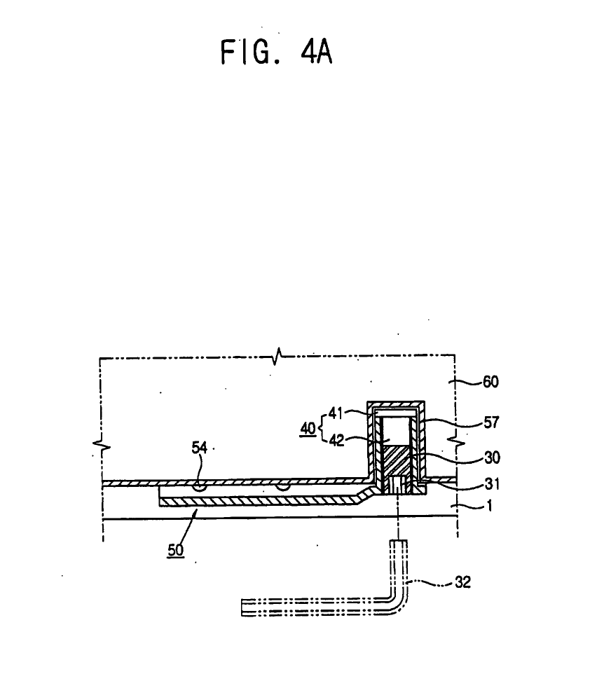

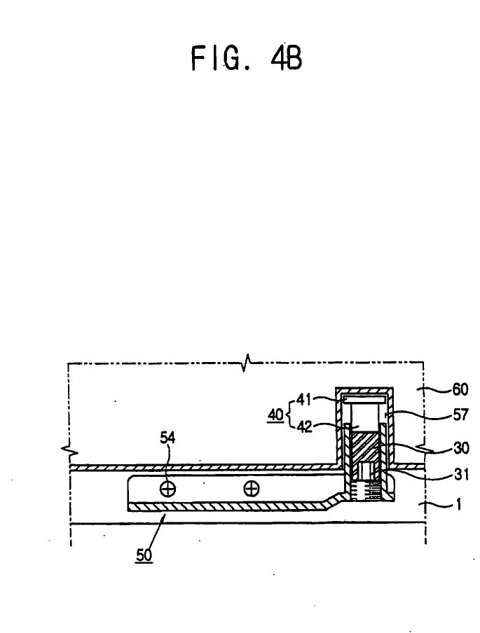

As shown in FIGS. 4a and 4b, when the height of the refrigerating compartment door 62 is lower than that of the freezing compartment door 61, the refrigerating compartment door 62 may be raised to make the height of refrigerating compartment door 62 and the freezing compartment door 61 identical. At this time, the tool 32 is inserted to the tool insertion part 31 of the height adjusting bolt 30 to raise the height adjusting bolt 30. Then, the height adjusting bolt 30 is screw-coupled with the accommodating part 56 of the hinge shaft 55 to be raised together with the height adjusting member 40.

Then, the head 41 of the height adjusting member 40 is contacted with the upper part of the hinge groove 57 of the refrigerating compartment door 62 to raise the refrigerating compartment door 62. The freezing compartment door 61 and the refrigerating compartment door 62 have the same height, thereby preventing the stepped pulley from occurring between the refrigerating compartment door 62 and the freezing compartment door 61.

Conversely, when the refrigerating compartment door 62 is lowered to make the height of the refrigerating compartment door 62 and the freezing compartment door 61 identical, the height adjusting bolt 30 rotates in a direction opposite to that described above. Then, the height adjusting bolt 30 and the height adjusting member 40 may be lowered altogether. The refrigerating compartment door 62 is lowered together with the height adjusting member 40 to lower the height thereof.

As described above, the hinge unit and the height adjusting unit may be installed without difficulty in the small installing space between the main door 60 and the auxiliary door 70 according to the present invention. As the hinge bracket 50 is provided as a slim type, it is not exposed to the outside much and provides an excellent external appearance.

When users want to adjust the height of the door, they can adjust it using a tool such as the wrench or the driver in a comfortable posture. Thus, the refrigerator is provided with the configuration, which adjusts the height of the door with solid coherence and is simplified.

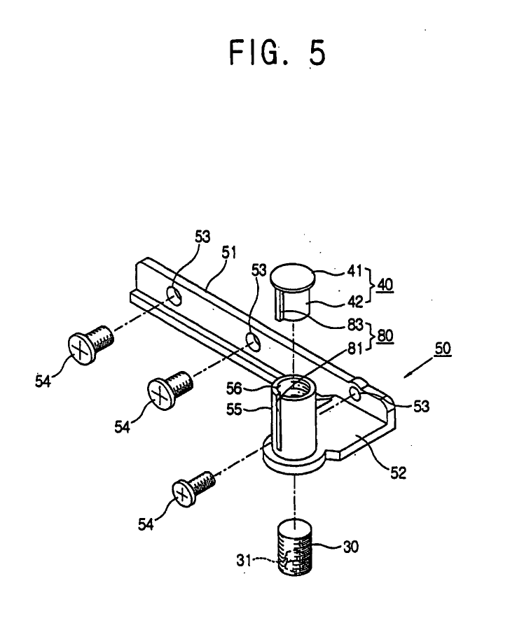

FIG. 5 is an exploded view of a rotation preventing part 80 provided in the hinge unit and the height adjusting unit in FIG. 3. As shown therein, the rotation preventing part 80 comprises a rotation preventing groove 81 which is provided in the hinge shaft 55, and a projection 83 which is provided in the height adjusting member 40 to be held in the rotation preventing groove 81 to prevent the height adjusting member 40 from rotating around an axis of the hinge shaft 55.

The rotation preventing groove 81 is elongated in a downward direction from an upper part of the hinge shaft 55 to accommodate the projection 83 provided in the height adjusting member 40.

The projection 83 is elongatedly protruded in a lengthwise direction from the leg 42 of the height adjusting member 40 to be accommodated in the rotation preventing groove 81.

As the projection 83 is inserted to the rotation preventing groove 81 when the height adjusting member 40 is coupled with the accommodating part 56 of the hinge shaft 55, the height adjusting member 40 does not rotate around the axis of the hinge shaft 55, (i.e., around the opening and closing directions of the refrigerating compartment door 62 with respect to the hinge shaft 55). Thus, when the door is open and closed, the height adjusting member 40 rotates together with the door, thereby rotating the height adjusting bolt 30 to prevent the height of the door from being changed.

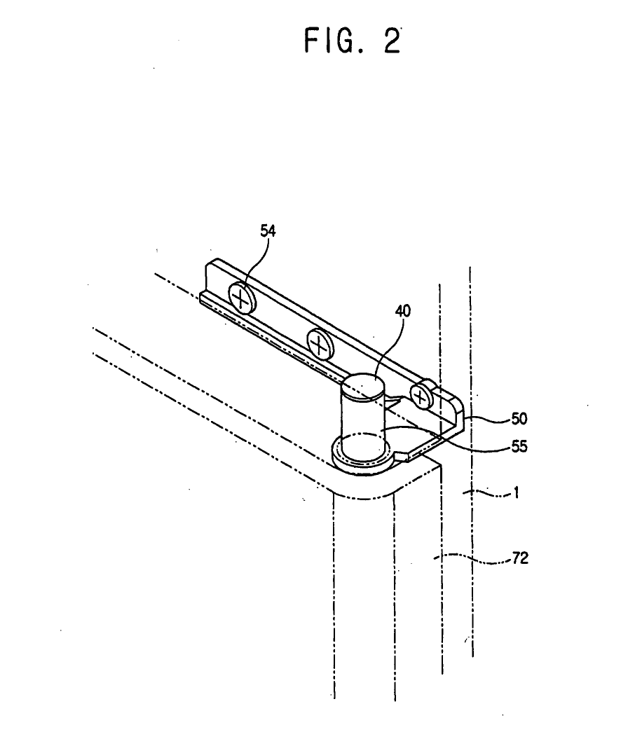

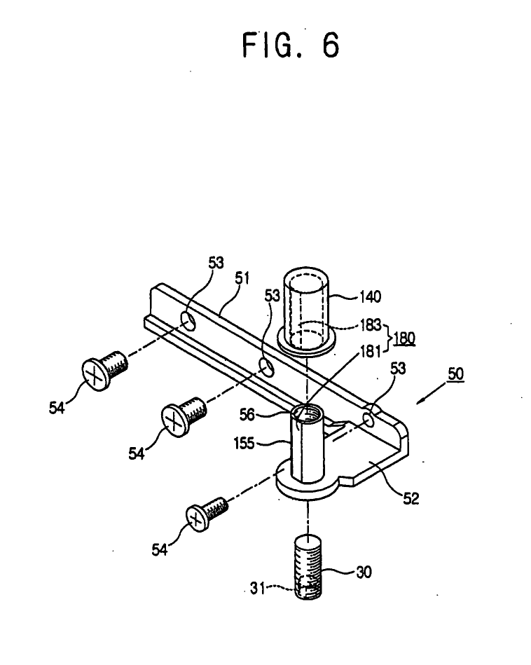

FIG. 6 is an exploded view of a hinge unit and a height adjusting unit of a refrigerator according to another embodiment of the present invention. As shown therein, the refrigerator according to the present invention may further comprises a rotation preventing unit 180 to prevent a height adjusting member 140 from rotating in opening and closing directions of a refrigerating compartment door 62 with respect to a hinge shaft 155 as similar to the method as shown in FIG. 5. The height adjusting member 140 is provided in an outside of the hinge shaft 155 and contactably accommodated in a hinge groove 57, apart from that shown in FIGS. 2 through 5. The height adjusting member 140 in FIG. 6 is contacted with a height adjusting bolt 30 as shown in FIGS. 4a and 4b to move in upward and downward directions together with the refrigerating compartment door 62.

The rotation preventing unit 180 comprises a rotation preventing part 181 which is provided in the hinge shaft 155, and a projecting part 183 which is provided in the height adjusting member 140 to be held in the rotation preventing part 181 to prevent the height adjusting member 140 from rotating around an axis of the hinge shaft 155, apart from those shown in FIG. 5.

The rotation preventing part 181 comprises a plain surface on an external circumferential surface of the hinge shaft 155 as an example of the present invention. At this time, the exterior of the hinge shaft 155 may be shaped like a cylinder to have a circular section. As shown in FIG. 6, the rotation preventing part 181 comprises a plain surface on a part of the external circumferential surface of the hinge shaft 155.

The projecting part 183 comprises a plate surface corresponding to the plain surface shape of the rotation preventing part 181 to be prevented from rotating in contact with the rotation preventing part 181. At this time, an inside surface of the height adjusting member 40 may be shaped like a cylinder to have a circular section. The projecting part 183 may be shaped like a plate surface on a part of the internal circumferential surface of the height adjusting member 140, as shown in FIG. 6.

As the projecting part 183 becomes adjacent to the rotation preventing part 181 when the height adjusting member 140 is coupled with the hinge shaft 155, the height adjusting member 140 may not rotate around the axial direction of the hinge shaft 155, (i.e., around the opening and closing directions of the refrigerating compartment door 62 with respect to the hinge shaft 155). Thus, when the door is open and closed, the height adjusting member 40 rotates together with the door, thereby rotating the height adjusting bolt 30 to prevent the height of the door from being changed.

Although a few embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A refrigerator comprising a refrigerator main body having at least one freezing compartment, and a door to open and close the freezing compartment, the refrigerator comprising:
a hinge unit comprising a hinge shaft which is provided in one of the refrigerator main body and the door and having an accommodating part to penetrate an inside of the hinge shaft, and a hinge groove which is provided in the other one of the refrigerator main body and the door to rotatably accommodate the hinge shaft; and
a height adjusting unit which is coupled with the hinge shaft and the hinge groove to adjust a height of the door, and comprises a height adjusting member which is provided between the hinge shaft and the hinge groove, and a height adjusting bolt which is screw-coupled with the accommodating part to move the height adjusting member in an axial direction of the hinge shaft and having a tool insertion part to which a tool is inserted.

2. The refrigerator according to claim 1, wherein the accommodating part penetrates in the hinge shaft in upward and downward directions, and the height adjusting member slides in upward and downward directions with respect to the hinge shaft, wherein a first side thereof is contacted with an internal surface of the hinge groove and a second side thereof is contacted with the height adjusting bolt.

3. The refrigerator according to claim 2, wherein the height adjusting member comprises a head which is exposed to an outside of the hinge shaft to be contacted with the internal surface of the hinge groove and a leg having a smaller diameter than the head contacts with the height adjusting bolt to slide within the accommodating part in upward and downward directions.

4. The refrigerator according to claim 1, wherein the accommodating part penetrates in the hinge shaft in the upward and downward directions, and the height adjusting member is provided in an outside of the hinge shaft to accommodate the hinge shaft and to be contacted with the hinge groove.

5. The refrigerator according to claim 4, wherein the hinge unit further comprises a hinge bracket which is disposed in the refrigerator main body to be positioned in a lower part of the door, and the hinge shaft is provided in the hinge bracket.

6. The refrigerator according to claim 5, wherein the hinge bracket comprises a first supporter to be coupled with the refrigerator main body and a second supporter which is provided in a transverse direction to a plate surface of the first supporter and comprising the hinge shaft.

7. The refrigerator according to claim 2, wherein the hinge unit further comprises a hinge bracket which is disposed in the refrigerator main body to be positioned in a lower part of the door, and the hinge shaft is provided in the hinge bracket.

8. The refrigerator according to claim 7, wherein the hinge bracket comprises:
a first supporter to be coupled with the refrigerator main body; and
a second supporter which is provided in a transverse direction to a plate surface of the first supporter and comprising the hinge shaft.

9. The refrigerator according to claim 2, further comprising a rotation preventing unit to prevent the height adjusting member from rotating in opening and closing directions of the door with respect to the hinge shaft.

10. The refrigerator according to claim 9, wherein the rotation preventing unit comprises a rotation preventing groove which is provided in the hinge shaft and a projection which is provided in the height adjusting member to be held in the rotation preventing groove to prevent the height adjusting member from rotating around an axis of the hinge shaft.

11. The refrigerator according to claim 4, further comprising a rotation preventing unit to prevent the height adjusting member from rotating in the opening and closing directions of the door with respect to the hinge shaft.

12. The refrigerator according to claim 11, wherein the rotation preventing unit comprises a rotation preventing part which is provided in the hinge shaft and a projection which is provided in the height adjusting member through the rotation preventing part to prevent the height adjusting member from rotating around the axis of the hinge shaft.

13. The refrigerator according to claim 12, wherein the rotation preventing part comprises a plain surface on an external circumferential surface of the hinge shaft and the projection comprises a plate surface corresponding to the plain surface of the rotation preventing part to be prevented from rotating in contact with the rotation preventing part.

14. A refrigerator comprising a refrigerator main body having at least one freezing compartment, and a door to open and close the freezing compartment, the refrigerator comprising:
a hinge bracket which is provided in the refrigerator main body;
a hinge shaft which is provided in the hinge bracket to rotatably support the door and formed with an accommodating part which penetrates an inside of the hinge shaft;
a hinge groove which is provided in a lower part of the door to rotatably accommodate the hinge shaft; and
a height adjusting bolt which is screw-coupled with the accommodating part to move in upward and downward directions within the accommodating part and to adjust a height of the door.

15. The refrigerator according to claim 14, further comprising a height adjusting member which is provided between the hinge shaft and the hinge groove to slide in the upward and downward directions by the height adjusting bolt.

16. The refrigerator according to claim 15, further comprising a rotation preventing unit to prevent the height adjusting member from rotating in opening and closing directions of the door with respect to the hinge shaft.

17. The refrigerator according to claim 16, wherein the rotation preventing unit comprises a rotation preventing part which is provided in the hinge shaft and a projection which is provided in the height adjusting member to prevent the height adjusting member from rotating around an axis of the hinge shaft to be held in the rotation preventing part.

18. The refrigerator according to claim 16, further comprising a rotation preventing groove which is provided in the hinge shaft and a projection which is provided in the height adjusting member to prevent the height adjusting member from rotating around the axis of the hinge shaft by being accommodated in the rotation preventing groove.

19. The refrigerator of claim 10, wherein the rotation preventing groove is elongated in a downward direction from an upper part of the hinge shaft to accommodate the projection provided in the height adjusting member.

20. The refrigerator of claim 19, wherein the projection is elongatedly protruded in a lengthwise direction from the leg of the height adjusting member to be accommodated in the rotation preventing groove.

21. The refrigerator of claim 6, wherein the hinge bracket is L-shaped.
